(19) United States
(12) Patent Application Publication
(10) Pub. No.: US 2009/0288682 A1
(43) Pub. Date: Nov. 26, 2009

(54) Borehole cleaning device

(75) Inventor: Josef Glogger, Buchloe (DE)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 12/454,729

(22) Filed: May 20, 2009

(30) Foreign Application Priority Data
May 21, 2008 (DE) 10 2008 001 908.9

(51) Int. Cl. B08B 5/04; A47L 7/02; B08B 9/04

(52) U.S. Cl. 134/8; 15/363

(57) ABSTRACT

A borehole cleaning device, includes a tubular shaft (12; 42), a hollow space (14) of which opens into the front opening (16; 46), a region (13; 43) adjoining the front opening and provided with a plurality of brush members (21; 51) extending radially outwardly, a suction opening (18; 48) provided in an end region of the shaft (12; 42) opposite the region (13; 43) adjoining the front opening (16; 46), and a region (19; 49) adjacent to the suction opening (18; 48) and extending at an angle to the region (13; 43) of the shaft (12; 42) adjoining the front opening (16; 46) for forming a handle (26; 56).

### BACKGROUND OF THE INVENTION

1. Field of the Invention

The present invention relates to a borehole cleaning device including a tubular shaft, the hollow space of which opens into a front opening and which has a region adjoining the front opening, a suction opening provided in an end region of the shaft opposite the region adjoining the front opening, and a plurality of brush members provided on the region of the shaft adjoining the front opening and extending radially outwardly. The present invention also relates to a method of cleaning a borehole with a borehole cleaning device described above.

2. Description of the Prior Art

For a chemical anchoring of fastening elements such as anchor rod, threaded rod, threaded sleeve, threaded anchor, or reinforcing iron, firstly, a borehole is formed in a constructional component such as a constructional part or workpiece. The borehole is then cleaned and is filled with a hardenable mass, e.g., a multi-component mortar mass. Thereafter, a fastening element is set into the borehole. After hardening of the mass, the fastening element has a high load-carrying capability.

A borehole is cleaned, e.g., blown out before it is filled with the hardenable mass, so that between the hardenable mass and the borehole wall, no separation layer, which might adversely affect adhesion of the hardenable mass to the borehole wall, is formed, e.g., by drilling dust produced at drilling or as a result of presence of moisture in the borehole.

German Publication DE 35 23 477 A1 discloses a borehole cleaning device having a shaft at the front end of which there is provided a loosely secured strip-off disc and which has, at least in one region, a hollow space which opens, at the front end of the shaft, into a front opening and into a radial opening spaced from the front end of the shaft. Between the front opening and the radial opening, there is provided a radially projecting elastic collar that strips off the drilling dust on the borehole wall during a reciprocating movement of the device. At the rear end of the shaft, there is provided a knob. For protection of the environment, there is provided a cover displaceably supported on the shaft and surrounding the borehole when the device is put thereon.

The drawback of the device described above consists in that the cleaning takes place only once by stripping the drilling dust off by the elastic collar.

German Publication DE 197 57 424 A1 discloses a borehole cleaning device including a tubular shaft the hollow space of which opens into a front opening and which has a region adjoining the front opening, a suction, opening radially outwardly, opening provided in an end region of the shaft opposite the region adjoining the front opening, and a plurality of brush members provided on the region of the shaft adjoining the front opening and extending radially outwardly. At the end of the shaft opposite the front opening, there is provided a shank for securing the device in a chuck of a drill. For an advantageous borehole cleaning, there is provided a suction head having a through-opening for the shaft and a connection element for a vacuum source.

The drawback of the device of DE 197 57 424 A1 consists in that the radial opening, which forms the suction opening, weakens the shaft at least in some regions, so that the performance of the device is insured only with a correspondingly bulky shaft. In addition, the possibility of manual handling of the device disclosed in DE 197 57 424 A1 for a long period of time is limited.

Accordingly, an object of the present invention is to provide a borehole cleaning device that can be economically produced, has a high stability, and can be easily handled manually.

### SUMMARY OF THE INVENTION

This and other objects of the present invention, which will become apparent hereinafter are achieved by providing a borehole cleaning device in which the region adjacent to the suction opening extends at an angle to the region of the shaft adjoining the front opening for forming a handle.

With a region of the shaft forming a handle, an easy and a convenient, for the user, handling of the borehole cleaning device is insured. The shaft is hollow over its entire longitudinal extent so that the hollow space of the shaft opens into the front opening, on one hand, and into the suction opening, on the other hand. Thus, the hollow space connects the suction opening with the front opening at the first end of the shaft. Even when an outer cover, which is placed on the constructional component, is provided, no underpressure, which can adversely affect the cleaning effect, is produced during the reciprocating movement of the device for cleaning the borehole.

Advantageously, the suction opening is provided the second end of the shaft opposite the front opening, which provides for an advantageous manufacturing of the shaft and, thus, of the device itself. The shaft advantageously is cut to a desired length from a tubular piece as a half-finished piece, with open ends forming the suction and front openings without any additional treatment of the shaft. Because the shaft does not have any radially opening bore, the shaft has a sufficiently stable shape even at a small wall thickness. In addition, no or very small air turbulence, which might hinder the air flow within the shaft, is produced. Thus, during the use of the device, there is a high-volume flow of the environmental air in the borehole, which insures an advantageous borehole cleaning.

Advantageously, there is provided connection means for connecting the region of the shaft adjacent to the suction opening and the region of the shaft adjoining the front opening with each other. The connection mans, e.g., can be formed as threaded means, which permits to screw the region of the shaft, which forms the handle and is located adjacent to the suction opening, with the shaft region adjoining the front opening. Alternatively, the handle-forming region of the shaft and the remaining portion of the shaft can be connected with each other by material-locking means such as, e.g., soldering or welding. In this case, advantageously, the handle is formed by a tubular section that, on one hand, opens into environment and, on the other hand, in the mounted condition of the handle section on the shaft, has a through-channel communicating with the suction opening. The additional section insures flow of the environmental air into the shaft and, thus, into the borehole.

Advantageously, the region of the shaft adjacent to the suction opening has, at least in some regions, a shaped profile, which provides for an easy and ergonomically advantageous holding of the device. The shaped profile of the handle section improves handling of the borehole cleaning device. The shaped profile, which is formed, e.g., as serrations, is provided, e.g., directly on the outer side of the shaft region adjacent to the suction opening. Alternatively, the shaped profile can be provided on a separate part that is securable adjacent to the second end of the shaft, e.g., by being glued, shrink-mounted, or pinned on. The separate part is formed, e.g., of a plastic material.

Advantageously, there is provided a suction head having a through-opening for the shaft and a connection element for a vacuum source. During a cleaning process, the drilling dust, which fills the borehole, is aspirated into the suction head and is delivered in the vacuum source through the connection element. The vacuum in the suction head and, thus, in the borehole, which is produced by the vacuum source, is compensated by the passive air flow through the shaft. As a vacuum source, e.g., a vacuum cleaner can be used the hose of which is connected with the connection element that is advantageously formed as a round union. The blow-in, e.g., of compressed air for cleaning the borehole is not any more necessary.

Advantageously, the through-opening is provided with sealing elements projecting radially inwardly. The sealing elements prevent an undesirable release of the drilling dust into environment during the operation of the borehole cleaning device in the region of the suction head with the through-opening.

The inventive method of cleaning of a borehole with the above-described borehole cleaning device, which also includes the suction head, includes essentially the following steps.

A hose of a vacuum source is connected with the connection element of suction head, and the suction head is positioned over the borehole. The shaft is introduced with its first end, i.e., with its region provided with brush members, into the borehole through the through-opening of the suction head. Alternatively, the region of the shaft provide with the brush members can be displaceably held but without a possibility of being lost, on the suction head. After positioning of the suction head, the region of the shaft with brush members is pushed into the borehole, and the vacuum source is actuated. After the region of the shaft adjacent to the suction opening and forming the handle has been grasped, the device is manually reciprocated for a certain time to and from the constructional component or the constructional part, whereby the brush members, which were inserted in the borehole, clean the borehole. Because of a vacuum created in the suction head and the borehole by the vacuum source, the environmental air passively flows through the shaft in the borehole and entrains the brushed-off drilling dust and the remaining drilling dust and moisture away. This insures an advantageous cleaning of the borehole, which insures adhesion of the hardenable mass to the borehole wall and, thereby, an advantageous anchoring of a chemically anchorable fastening element.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS

The drawings show:

FIG. 1 a longitudinal cross-sectional view of a first embodiment of a borehole cleaning device according to the present invention; and;

FIG. 2 a longitudinal cross-sectional view of a second embodiment of a borehole cleaning device according to the present invention.

In the drawings, the same parts are designated with the same reference numerals.

### DETAILED DESCRIPTION OF THE PREFERRED EMBODIMENTS

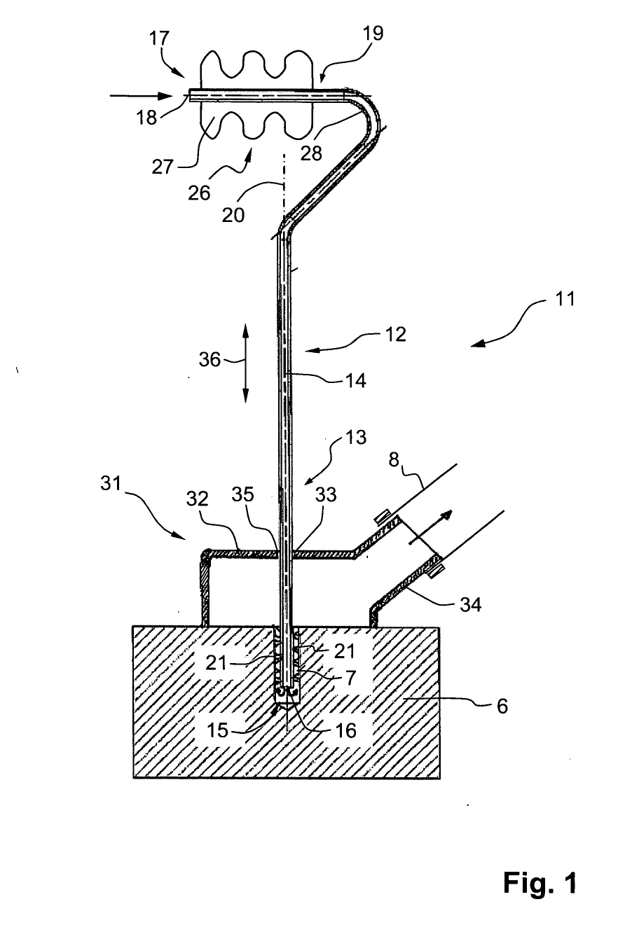

A device 11 according to the present invention for cleaning a borehole 7 formed in a constructional component 6, e.g., a concrete wall, and which is shown in FIG. 1, has a tubular, hollow over its entire longitudinal extent, shaft 12 the elongate, circumferentially closed, hollow space 14 of which opens in a front opening 16 at a first end 15 of the shaft 12 and opens, at a second end 17 of the shaft 12 opposite the first end 15, in a suction opening 18 that communicates with the front opening 16. A region 13 of the shaft 12, which adjoins the front opening 16, is provided with several, projecting radially outwardly, and axially spaced brush elements which form brush members 21 circumferentially arranged in the region 13 of the shaft 12.

In the region 19 of the shaft 12 adjacent to the suction opening 18 and adjacent to the second end 17, there is provided a bent 28, so that the region 19 of the shaft 12 adjacent to the suction opening 18 forms a handle 26. the handle 26, e.g., extends in the region 19 of the shaft 12, substantially at a right angle to a longitudinal axis 20 of the region 13 of the shaft 12 adjoining the front opening 16.

For a profiled formation of the handle 26, a separate element 27, e.g., of a plastic material is mounted, e.g., shrinked, on the region 19 of the shaft 12 that adjoins the suction opening 18.

There is further provided a suction head 31 having a bell-shaped housing having a through-opening 33 for the region 13 of the shaft 12 that adjoins the front opening 16, and a connection union in form a connection element 34 for a vacuum source, not shown. The through-opening 33 is provided with projecting radially inwardly, lamella-shaped sealing elements 35.

For cleaning the borehole 7 with the device 11, hose 8 of a vacuum cleaner, not shown, that serves as a vacuum source, is secured on the connection element 34 of the suction head 31. Then, the suction head 31 is so positioned over the borehole 7 that the region 13 of the shaft 12, which adjoins the front opening 16 and is provided with brush member 21, is introduced in the borehole 7. After turning the vacuum source on, the shaft 12 is manually reciprocated in the direction of the double arrow 36, with the brush members 21 brushing the wall of the borehole 7 off. The drilling dust, which is produced during the brushing process is aspirated from the borehole 7 by the suction head 31 and through the connection element 34, with the passive environmental air being aspirated into the borehole 7 through the suction opening 18 and the hollow space 14.

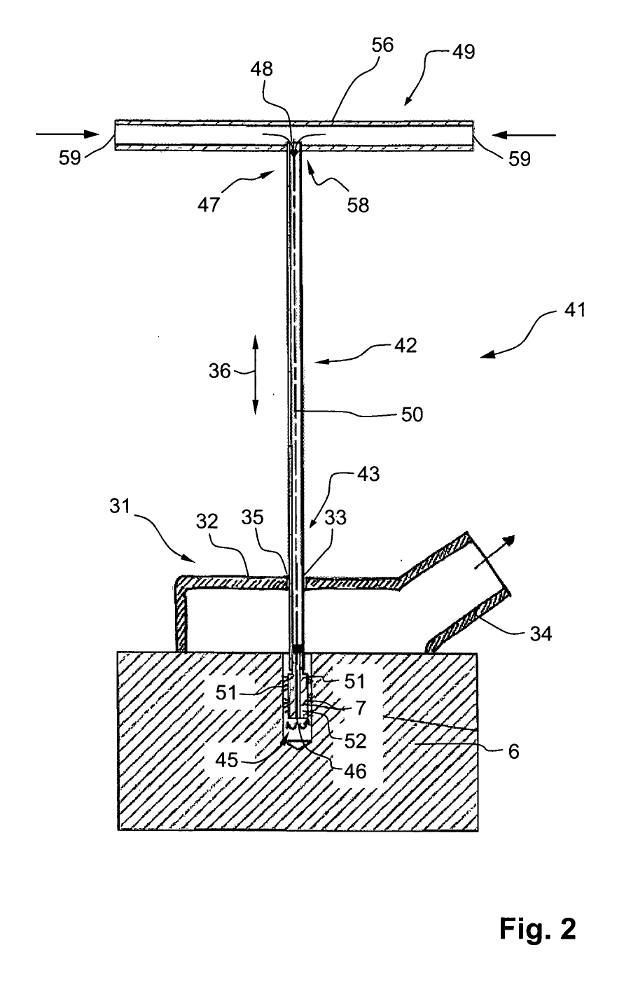

The device 41 for cleaning the borehole 7, which is shown in FIG. 2, differs from the above-described device 11 in that the handle 56 and the shaft 42 are formed of several parts. In the device 41, a region 49 of the shaft 12 adjacent to the suction opening 48 and which forms the handle 56, and the region 43 of the shaft 12 adjacent to the front opening 46 are connected with each other by threaded connection means formed by a connection element 58. To this end, the region 43 of the shaft 12 adjacent to the front opening 46 is provided, at its second end, with a section having an outer thread, and the region 49 of the shaft 12 adjacent to the suction opening 48 and forming the handle 56 is provided with a bore having an inner thread, so that the handle 56 can be screwed on the threaded suction of the shaft 42. The handle 56 extends, in its longitudinal direction, transverse to the longitudinal axis 50 of the region 43 of the shaft 42, so that the region 49 of the shaft 42 adjacent to the suction opening 48 extends at an angle to region 43 of the shaft 42 provided with brush members 51. The handle 56 is provided, on its outer side, with serrations forming an appropriate profile. The handle 56 has a tubular shape and is open at both of its ends 59. During the operation of the borehole cleaning device 41, the environmental air can passively flow through the openings at the ends 59 of the handle 56 and through the suction opening 48 and the shaft 42 into the borehole 7.

The region 43 of the shaft 42 adjacent to the front opening 46 has, at its first end 45, a separate, releasable connectable, e.g., by threaded means, element 52 on which radially projecting, brush members 51 are provided. This insures an easy replacement of the brush members 51, if needed.

Though the present invention was shown and described with references to the preferred embodiments, such are merely illustrative of the present invention and are not to be construed as a limitation thereof and various modifications of the present invention will be apparent to those skilled in the art. It is therefore not intended that the present invention be limited to the disclosed embodiments or details thereof, and the present invention includes all variations and/or alternative embodiments within the spirit and scope of the present invention as defined by the appended claims.

What is claimed is:

1. A borehole cleaning device, comprising a tubular shaft (12; 42) having a front opening (16; 46) with a shaft hollow space (14) opening into the front opening (16; 46), a region (13; 43) adjoining the front opening, a suction opening (18; 48) provided in an end region of the shaft (12; 42) opposite the region (13; 43) adjoining the front opening (16; 46), and a region (19; 49) adjacent to the suction opening (18; 48) and extending at an angle to the region (13; 43) of the shaft (12; 42) adjoining the front opening (16; 46) for forming a handle (26; 56); and a plurality of brush members (21; 51) provided on the region (13; 43) of the shaft (12; 42) adjoining the front opening (16; 46) and extending radially outwardly.

2. A borehole cleaning device according to claim 1, wherein the suction opening (18; 48) is provided at an end (17; 47) of the shaft (12; 420 opposite the front opening (16; 46).

3. A borehole cleaning device according to claim 1, further comprising connection means (58) for connecting the region (49) of the shaft (42) adjacent to the suction opening (48) and the region (43) of the shaft (42) adjoining the front opening (16) with each other.

4. A borehole cleaning device according to claim 1, wherein the region (49) of the shaft (42) adjacent to the suction opening (18) has, at least in some regions, a shaped profile.

5. A borehole cleaning device according to claim 1, further comprising a suction head (31) having a through opening (33) for the shaft (12; 42) and a connection element (34) for a vacuum source.

6. A borehole cleaning device according to claim 5, wherein the through-opening (33) is provided with sealing elements (35) projecting radially inwardly.

7. A method of cleaning a borehole, comprising the steps of:
providing a borehole cleaning device including a tubular shaft (12; 42) having a front opening (16; 46) with a shaft hollow space (14) opening into the front opening (16; 46), a region (13; 43) adjoining the front opening, a suction opening (18; 48) provided in an end region of the shaft (12; 42) opposite the region (13; 43) adjoining the front opening (16; 46), and a region (19; 49) adjacent to the suction opening (18; 48) and extending at an angle to the region (13; 43) of the shaft (12; 42) adjoining the front opening (16; 46) for forming a handle (26; 56), a plurality of brush members (21; 51) provided on the region (13; 43) of the shaft (12; 42) adjoining the front opening and extending radially outwardly, and a suction head (31) having a through-opening for the shaft (12; 42) and a connection element (34) for a vacuum source;
connecting the vacuum source with the connection element (34) of the suction head (31);
positioning the suction head (31) over the borehole (7);
actuating the vacuum source; and
manually reciprocating the shaft (12; 42) which has been introduced into the borehole (7), whereby the brush members (21; 51) brush off a wall of the borehole (7), and drilling dust, which is produced during a brush-off process, is aspirated by the suction head (31) and through the connection element thereof, and an environmental air is aspirated into the borehole (7) through the suction opening (18; 48).
